(19) United States
(12) Patent Application Publication
(10) Pub. No.: US 2011/0202252 A1
(43) Pub. Date: Aug. 18, 2011

(54) COMPANION CHIP FOR ENGINE CONTROL SIGNAL PROCESSING

(76) Inventors: Stephen Schmitt, Nuertingen (DE); Juergen Hanisch, Bempflingen (DE)

(21) Appl. No.: 12/673,313

(22) PCT Filed: Jul. 23, 2008
(86) PCT No.: PCT/EP08/59635

§ 371 Date: Mar. 2, 2011

(30) Foreign Application Priority Data
Aug. 16, 2007 (DE) 102007038540.6

(51) Int. Cl. F02D 28/00

(52) U.S. Cl. 701/102

(57) ABSTRACT

A companion chip for engine control signal processing. The companion chip includes a signal pre-processing circuit which is developed for the computation of an interpolation and a tangential slope of an engine control signal.

### FIELD OF THE INVENTION

The present invention relates to a companion chip for engine control and a method for controlling engine control signals in a companion chip.

### BACKGROUND INFORMATION

The development of hardware and software for engine control units keeps on becoming more difficult because of cost pressure in the automobile field, and a simultaneous specification of new exhaust gas norms.

To relieve a microcontroller of today's control systems, a companion chip is often used, which supports the microcontroller in the execution of its tasks. Depending on the purpose of the application of the control system, this requires the subdivision or the partitioning of required functions between the microcontroller and the companion chip. In the engine management of a vehicle, for example, this may be done according to the requirements on speed recording and fuel injection.

Besides algorithms for filtering, a computation of the slope or an interpolation of signal values is required for many tasks of signal processing in the companion chip. Thus, for example, one may detect the closing time of an injection component by a change in the slope in the scanned signal. In modern Diesel engines, the direct injector is more and more successful. Injection quantity and time are increasingly no longer controlled mechanically, but rather electronically by modules.

Interpolation of signal values becomes necessary, since, because of multiplexing the ADC (analog/digital controller) channels, the signals cannot be scanned in real time under certain circumstances.

During the engine injection, the injection pressure is held in reserve in a pressure reservoir (up to a maximum of 2000 bar), whereas in other injection systems the required injection pressure is built up only when needed. The electrohydraulically controlled injection nozzles are connected in common with the high pressure pipe that opens out into the pressure reservoir. In this way, short opening times (observation windows of 0.1 to 0.2 ms) may be achieved, which make a pre-injection and a post-injection implementable. Pre-injection (which is also possible using other injection systems) has the effect of a brief ignition delay and a noise reduction of the subsequent combustion of the main injection. Post-injection takes care of declining nitrogen oxide emissions, together with a catalytic converter. An additional advantage of this injection system is that the injection pressure is able to be stipulated independently of the engine speed, in other systems, the injection pressure also rises with increasing engine speed.

### SUMMARY

It is an object of the present invention to provide a cost-effective and flexible companion chip for the engine control signal processing.

This object is attained by a companion chip for engine control signal processing, the companion chip including a signal pre-processing circuit which is developed for the computation of an interpolation and a tangential slope of an engine control signal. According to an embodiment of the present invention for the engine control signal processing, the computation for the interpolation of signal values and the computation of a tangential slope are able to be carried out in common. These computations may advantageously be implemented using a common hardware circuit, in this context.

In one advantageous embodiment, the companion chip computes the interpolation according to the formula

$${x}_{2} = \frac{( {x}_{2}^{′} - {x}_{1}^{′} ) * ( {t}_{2} - {t}_{1}^{′} )}{( {t}_{2}^{′} - {t}_{1}^{′} )} + {x}_{1}^{′} ,$$

where x₂ is a signal value at time t₂, and is located on a course of curve between signal value x′₁ at time t′₁ and signal value x′₂ at time t′₂. The computation of the interpolation is made thereby in a favorable and flexible manner.

In another advantageous embodiment, the companion chip computes the tangential slope according to the formula

$$\frac{Δ x}{Δ t} = \frac{{x}_{2}^{′} - {x}_{1}^{′}}{{t}_{2}^{′} - {t}_{1}^{′}} , \\ where \frac{Δ x}{Δ t}$$

is a tangential slope between signal value x′₁ at time t′₁ and signal value x′₂ at time t′₂. The computation of the tangential slope is made thereby in a favorable and flexible manner.

In one advantageous embodiment, the signal preprocessing circuit includes a division circuit. A computation of the interpolation and a computation of the tangential slope are thereby made using a common hardware circuit. Thus, computations of the interpolation and the tangential slope are favorably and flexibly carried out.

In one additional embodiment, the division circuit includes a sequential divider having 3,000 gates and a clock pulse frequency of 100 MHz. This implements a signal preprocessing circuit having low cost and high performance.

In one additional embodiment, the division circuit includes a parallel divider having 33,000 gates and a clock pulse frequency of 31.5 MHz. This implements a signal preprocessing circuit having low cost and high performance.

In another advantageous embodiment, the signal preprocessing circuit includes 15,000 gates. This embodiment achieves an effective reconciliation between the complexity of the signal preprocessing and additional components such as adders and subtractors as well as pipelining and cost-effective signal preprocessing.

In still another advantageous embodiment, the companion chip is developed to record a closing time of an injection component in response to a change in a tangential slope in a scanned signal. A favorable and reliable engine control is achieved by this embodiment.

In yet another advantageous embodiment, the analog/digital controller channels, which transmit the engine control signals, are combined in one multiplex unit. A favorable and reliable engine control is achieved by this embodiment.

The above object may also be attained by a method for controlling engine control signals in a companion chip, which includes the step of the computation of an interpolation and a tangential slope of the engine control signals in one signal preprocessing circuit. According to an example embodiment of the present invention, computations for the interpolation of signal values and the computation of a tangential slope are able to be carried out in common. These computations may be implemented using a common hardware circuit, in this context.

### BRIEF DESCRIPTION OF THE DRAWINGS

A specific embodiment according to the present invention, of a companion chip for engine control signal processing will be explained in greater detail below, with the aid of an exemplary embodiment. Identical or identically acting parts are provided with the same reference symbols.

FIG. 1 shows a voltage curve in the case of a piezo-Diesel injection.

FIG. 2 shows a course of curve to explain the computation of an interpolation and of a tangential slope.

FIG. 3 shows a hardware configuration for signal preprocessing for the computation of an interpolation and a tangential slope.

FIG. 4 shows a resource utilization in gates of hardware dividers.

### DETAILED DESCRIPTION OF EXAMPLE EMBODIMENTS

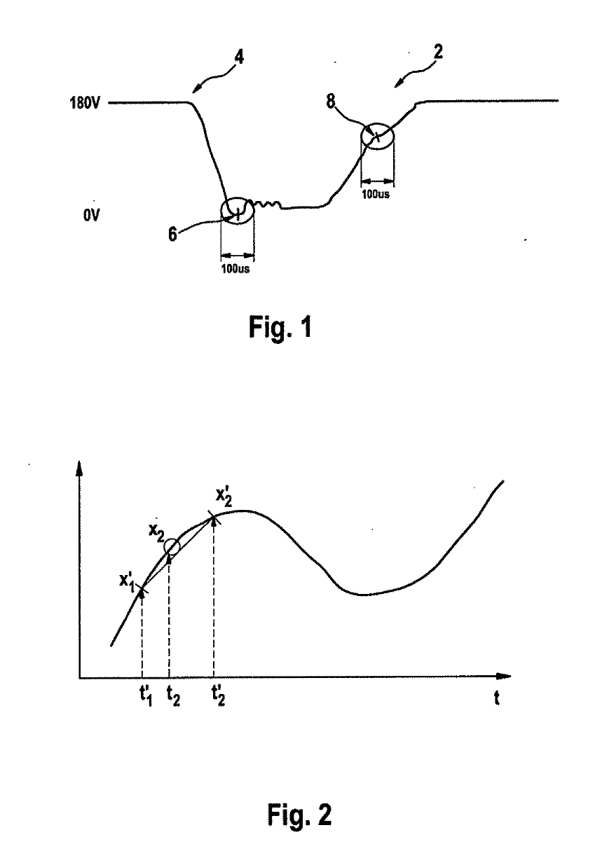

FIG. 1 shows a voltage course of curve 2 in the case of a piezo-Diesel injection. High injection pressures of currently more than 1.750 bar atomize the fuel to be very fine. Uniformly precise metering, as well as the smallest and large fuel quantities and switching speed permit adjusting the injection profile very accurately to the respective operating state of the engine.

By using flexible multiple injection, for example, the combustion curve in the cylinder may be formed, and thereby the combustion process may be optimized. Diesel engines having PCR (piezo common rail) injection save up to 25% in fuel, as compared to a naturally aspirated Otto engine. Compared to conventional Diesel engines, PCR technology offers up to 15% consumption advantage in overall vehicle coordination and facilitates the satisfaction of emission norms.

An efficient piezo control in the engine control unit exhausts the technical potential of technology. The durably high quality of injection over the mileage of a commercial vehicle is among the advantages, in this instance. For this purpose, the control compensates for manufacturing tolerances and environmental influences. The piezo driver is able to utilize the properties of an actuator even for injector-selective control, in order to compensate for mechanical and hydraulic deviations. Altogether, piezo technology thus makes possible precise, economical and reliable injection systems.

In Diesel piezo injection, starting time 4 for opening the injection component in voltage course of curve 2 is able to be detected directly before a voltage drop of 180 V to almost 0 V. At this voltage level, opening time 6 follows. After that, closing time 8 of the injection component may be detected by a change in the slope in the scanned signal. An observation window of opening time 6 and of closing time 8 has a duration of approximately 100 μs in each case.

A feature search for opening an opening component, at opening time 6 is based on a minimum search in voltage course of curve 2. By contrast, a feature search for closing the opening component, at closing time 8 is based, at closing time 8, on a plateau search in voltage course of curve 2, that is, on a change in the gradient of the slope of voltage course of curve 2.

Interpolation of signal values becomes necessary, since signals 6, 8 cannot be scanned in real time under certain circumstances, because of the multiplexing of the analog/digital controller channels.

FIG. 2 shows a course of curve to explain the computation for the interpolation of a signal value and the computation of a tangential slope of the signal value. These computations may be implemented using a common hardware circuit.

The interpolation of the signal value x₂ may be computed, in this instance, by the formula

$${x}_{2} = \frac{( {x}_{2}^{′} - {x}_{1}^{′} ) * ( {t}_{2} - {t}_{1}^{′} )}{( {t}_{2}^{′} - {t}_{1}^{′} )} + {x}_{1}^{′} ,$$

where x₂ is the signal value at time t₂, and is located on the curve between signal value x′₁ at time t′₁ and signal value x′₂ at time t′₂.

Furthermore, the slope of the tangent of the signal value may be calculated according to the formula

$$\frac{Δ x}{Δ t} = \frac{{x}_{2}^{′} - {x}_{1}^{′}}{{t}_{2}^{′} - {t}_{1}^{′}} , \\ where \frac{Δ x}{Δ t}$$

is the tangential slope between signal value x′₁ time t′₁ and signal value x′₂ at time t′₂.

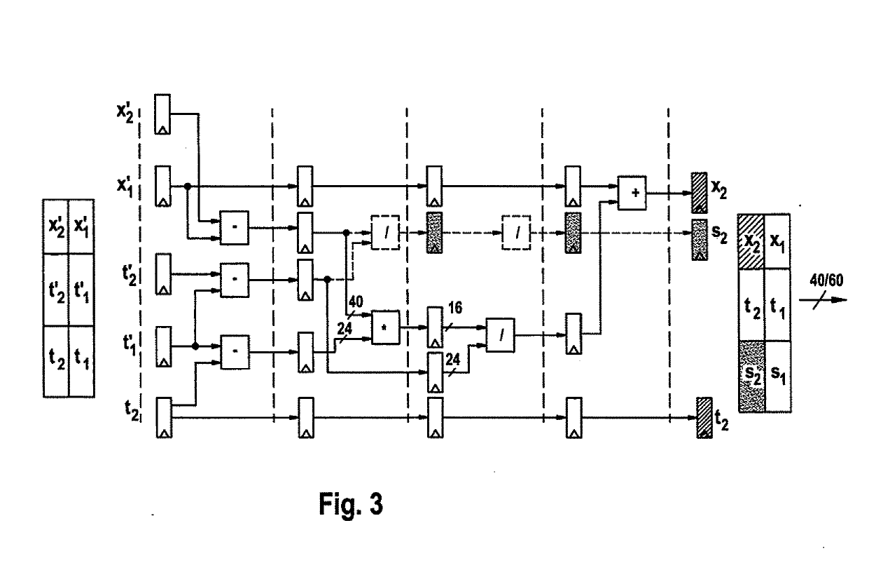

These computations may be made using a common hardware circuit, which is shown in FIG. 3.

FIG. 3 shows a hardware configuration for signal preprocessing for the computation of an interpolation and a tangential slope.

One may see in FIGS. 2 and 3 that a division is required for the interpolation and the tangent calculation. For this reason, a hardware circuit has to implement this division. In this context, there is a trade-off between chip area and speed. One favorable implementation of the division may be set up in future implementations for companion chips, variably for predetermined requirements.

A sequential 24-bit wide divider requires, for instance, ca. 3,000 gates at a running time of 35 clock pulses and a clock pulse frequency of 100 MHz. The handling of 360 analog/digital converter values at CSC-P (combustion signal control-pressure) would thus require 126 μs. If the division is performed on the PCP (peripheral control processor) of the TriCore™, this requires 45 clock pulses having a duration of 12.5 ns to 13 ns each This being the case, the computation of one datum takes 0.5 to 0.6 μs, and the computation of the CSC-P values takes 216 μs. This will be unacceptable for future engine controls. The Cortex-M3™ also supports a division algorithm in hardware. It has a speed of 4 bit/cycle, in this instance.

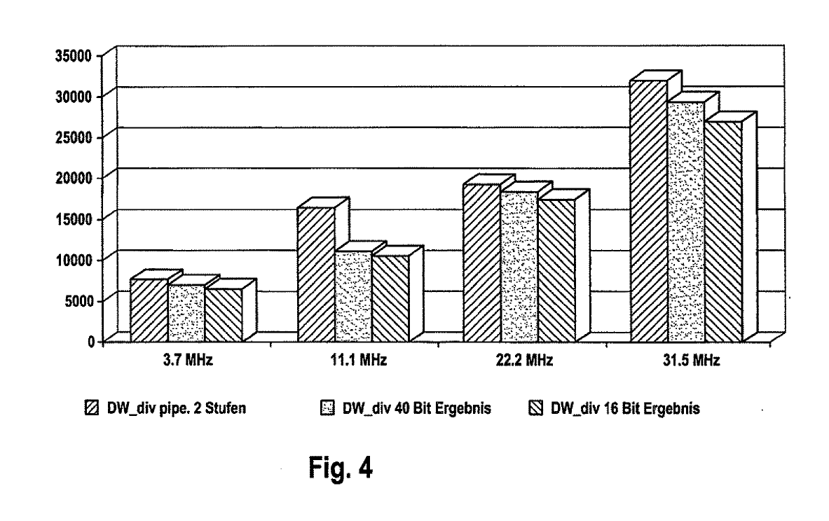

FIG. 4 shows a resource utilization in gates of hardware dividers. This figure shows the resource utilization in gates of hardware dividers, from a Synopsis™DesignWare library for one clock pulse and having two pipeline stages for different clock pulse frequencies. A hardware divider for the companion chip will be somewhere between a purely sequential and a purely parallel divider.

The signal preprocessing is used for the interpolation as well as for the tangent computation, and for the reduction of analog/digital controller data. As shown in FIG. 4, a division unit is a central component of the signal preprocessing, for which there are different implementation variants.

The division unit will move between a purely sequential divider having 3,000 gates and 100 a MHz clock pulse frequency and a purely parallel divider having 33,000 gates and a 31.5 MHz clock pulse frequency. Based on the complexity of the signal preprocessing and additional components, such as adders and subtractors as well as pipelining, ca. 15,000 gates are required for the signal preprocessing.

1-10. (canceled)

11. A companion chip for engine control signal processing, comprising:
a signal preprocessing circuit adapted to compute an interpolation and a tangential slope of an engine control signal.

12. The companion chip for engine control signal processing as recited in claim 11, wherein the companion chip is adapted to compute the interpolation according to a formula
$${x}_{2} = \frac{( {x}_{2}^{′} - {x}_{1}^{′} ) * ( {t}_{2} - {t}_{1}^{′} )}{( {t}_{2}^{′} - {t}_{1}^{′} )} + {x}_{1}^{′} ,$$
where x₂ is a signal value at time t₂, and is located on a course of curve between signal value x′₁ at time t′₁ and signal value x′₂ at time t′₂.

13. The companion chip for engine control signal processing as recited in claim 11, wherein the companion chip computes the tangential slope according to a formula
$$\frac{Δ x}{Δ t} = \frac{{x}_{2}^{′} - {x}_{1}^{′}}{{t}_{2}^{′} - {t}_{1}^{′}} , \\ where \frac{Δ x}{Δ t}$$
is a tangential slope between signal value x′₁ at time t′₁ and signal value x′₂ at time t′₂.

14. The companion chip for engine control signal processing as recited in claim 11, wherein the signal preprocessing circuit includes a division circuit.

15. The companion chip for engine control signal processing as recited in claim 14, wherein the division circuit includes a sequential divider having 3,000 gates and a clock pulse frequency of 100 MHz.

16. The companion chip for engine control signal processing as recited in claim 14, wherein the division circuit includes a parallel divider having 33,000 gates and a clock pulse frequency of 31.5 MHz.

17. The companion chip for engine control signal processing as recited in claim 11, wherein the signal preprocessing circuit includes 15,000 gates.

18. The companion chip for engine control signal processing as recited in claim 11, wherein the companion chip is adapted to record a closing time of an injection component in response to a change in a tangential slope in a scanned signal.

19. The companion chip for engine control signal processing as recited in claim 11, wherein the analog/digital controller channels which transmit the engine control signals, are combined in one multiplex unit.

20. A method for controlling engine control signals in a companion chip, comprising:
computing an interpolation and a tangential slope of the engine control signals in one signal preprocessing circuit.
